(19) United States
(12) Patent Application Publication
(10) Pub. No.: US 2016/0066098 A1
(43) Pub. Date: Mar. 3, 2016

(54) Compact, Wide-Frequency Range, Loudspeaker Transducer

(71) Applicant: Audio Design Experts, Inc., Fountain Valley, CA (US)

(72) Inventor: Donald J. North, Los Angeles, CA (US)

(73) Assignee: AUDIO DESIGN EXPERTS, INC., Fountain Valley, CA (US)

(21) Appl. No.: 14/835,741

(22) Filed: Aug. 26, 2015

Related U.S. Application Data
(60) Provisional application No. 62/042,187, filed on Aug. 26, 2014.

(51) Int. Cl. H04R 7/20; H04R 9/04

(52) U.S. Cl. CPC H04R 7/20; H04R 9/04

(57) ABSTRACT

A speaker system having a voice coil and diaphragm supported within a speaker frame, and three suspension systems, where one suspension system includes at least three wires extending between the voice coil and the speaker frame, one to carry a positive charge, another to carry a negative charge, and yet another one that carries no charge, where the three wires are positioned so as to permit axial movement of the voice coil without restraint of the voice coil by the wires.

The application claims the benefit of priority pursuant to 35 U.S.C. 119(e) and is entitled to the benefit of the filing date of U.S. Provisional Patent Application 62/042,187, filed on Aug. 26, 2014, the contents of each of which are hereby incorporated by reference in its entirety.

### BACKGROUND

The present invention relates generally to a loudspeaker having a diaphragm moving assembly that provides greater stability at maximum diaphragm excursions to improve sound quality.

A traditional speaker design is comprised of a diaphragm, frame, a motor assembly, and two suspension assemblies, known as a surround and spider. The magnet, voice coil, pole and yoke comprise the motor assembly. Sound from a speaker is generated from the application of an electric signal to the voice coil, causing an electric current to flow and produce an electric field from the voice coil which crosses magnetic flux from the magnet assembly. This cross product of the electric field with the magnetic field causes axial movement of the voice coil and speaker's diaphragm along an axis orthogonal to the plane of the diaphragm.

A traditional speaker suspension controls and ultimately limits the movement of the diaphragm along the pole. A typical speaker includes two suspensions: a surround and a spider. The surround suspension couples the outer periphery of the diaphragm to the speaker frame. The spider suspension, axially spaced behind the surround suspension, couples the voice coil to the speaker frame.

The two suspensions work together to maintain linear movement characteristics, also known as excursion, of the voice coil and diaphragm. Since the diaphragm is connected to the voice coil, the diaphragm's movement generates compression and rarefactions in the air which are perceived as sound by the human ear. It is important to maintain linear, stable excursion of the diaphragm and voice coil within the magnetic structure in order to minimize instability in diaphragm movement and to allow the rapid movements that generate a wide range of frequencies.

The typical audible frequency range for human ears is between 20 to 20,000 hertz. In order to generate a 20 hertz frequency, a diaphragm has to move 20 times per second. Similarly, to generate a 20,000 frequency, a diaphragm has to move 20,000 times per second.

The sound pressure level of a speaker is determined by the surface area of the diaphragm and by the amount of excursion per vibration. In other words, the more air that is pushed by the diaphragm's movement, the louder the sound generated. To maintain a constant sound pressure level, a speaker diaphragm needs to move 4 times the excursion for every halving of frequency. A traditional speaker design is constrained by the fact that it is very difficult to produce a single speaker capable of producing the entire range of audible frequency with meaningful sound volume levels.

With the advancements in amplifier efficiency and battery power and energy density, there is a desire to create compact, portable speakers that can produce sound quality and volume levels normally associated with much larger speaker systems.

To reproduce a wide frequency range, for example 60 Hz-15 kHz, from a compact speaker, the speaker needs to be small in size with a typical diaphragm diameter of 1 to 2 inches. In order to reproduce the low bass frequencies, the diaphragm and voice coil must move a substantial distance in a stable manner without wobbling and touching against the magnetic structure. In a typical speaker with surround and spider systems, the surround and spider provide sufficient stabilization. In an ultra-compact, high-excursion, speaker transducer, however, the surround and spider may prove inadequate to prevent unacceptable amounts of wobbling. In such a case, the speaker would require additional stability measures to effectively produce quality sound.

### SUMMARY

In one embodiment of the present invention, a speaker system is provided comprising a voice coil and diaphragm supported within a speaker frame. In one example, the speaker system comprises a first suspension system comprising a surround securing a diaphragm to the speaker frame, a second suspension system comprising a spider connecting the voice coil to the speaker frame, and a third suspension system comprising at least three wires extending between the voice coil and the speaker frame, at least one of the wires configured to transmit a positive charge, at least another one of the wires configured to transmit a negative charge, and at least yet another one of the wires configured so as to not to carry any charge, where the three suspension systems are configured and positioned so as to permit axial movement of the voice coil to produce sound while minimizing distortion. In another example, the third suspension system consists only of three wires. If desired, the three wires may be radially spaced at about 120 degrees apart.

In another embodiment, a speaker system is provided comprising a voice coil and diaphragm supported within a speaker frame, wherein the speaker system comprises three suspension systems, wherein the first and second suspension system are secured to the voice coil and the speaker frame, and wherein the first suspension system comprises at least three wires, one of which is not electrically actively.

### BRIEF DESCRIPTION OF THE FIGURES

The aforementioned objects and advantages of the present invention, as well as additional objects and advantages thereof, will be more fully understood hereinafter as a result of a detailed description of a preferred embodiment when taken in conjunction with the following drawings in which:

FIG. 1 shows a front perspective view of one embodiment of the present invention;

FIG. 2A shows a cross-sectional perspective view of the embodiment of FIG. 1;

FIG. 2B shows a cross-sectional elevational view of the embodiment of FIG. 1;

FIG. 3 shows a front perspective view of the embodiment of FIG. 1 with the diaphragm and surround missing;

FIG. 4 shows a plan view of the front side of the embodiment of FIG. 1 with the diaphragm and surround missing;

FIG. 5 shows a plan view of the rear side of the embodiment of FIG. 1.

### DETAILED DESCRIPTION OF CERTAIN EMBODIMENTS

In order to increase frequency range, increase sound volume level, and reduce wobbling, a multi-wire, stabilization, assembly is provided for compact speakers. The multi-wire, stabilization, assembly helps balance the dynamic diaphragm-voice coil moving assembly to provide greater stability at maximum diaphragm excursion, translating into greater sound volume output, increased frequency range, and improved sound quality. The multi-wire stabilization, assembly can also be used to conduct electricity to the voice coil.

In one embodiment, a multi-wire stabilization, assembly for use on a speaker comprises at least three wires separated by about 120 degrees, for example, at the outer diameter of the voice coil's bobbin, and which wires terminate at mounts on the speaker frame. Other embodiments include a greater or lesser degree of separation between wires. Among other advantages, the use of evenly-spaced tinsel wire around the bobbin of the voice coil helps balance the dynamic diaphragm-voice coil moving assembly to provide greater stability at maximum diaphragm excursion, translating into greater volume output, increased frequency range, and improved sound quality.

In some embodiments, the wires may be tinsel wires, braided wires, or combinations thereof. In some embodiments, the wires may be dressed to form a generally C-shaped configuration between the voice coil and the mounts of the speaker frame.

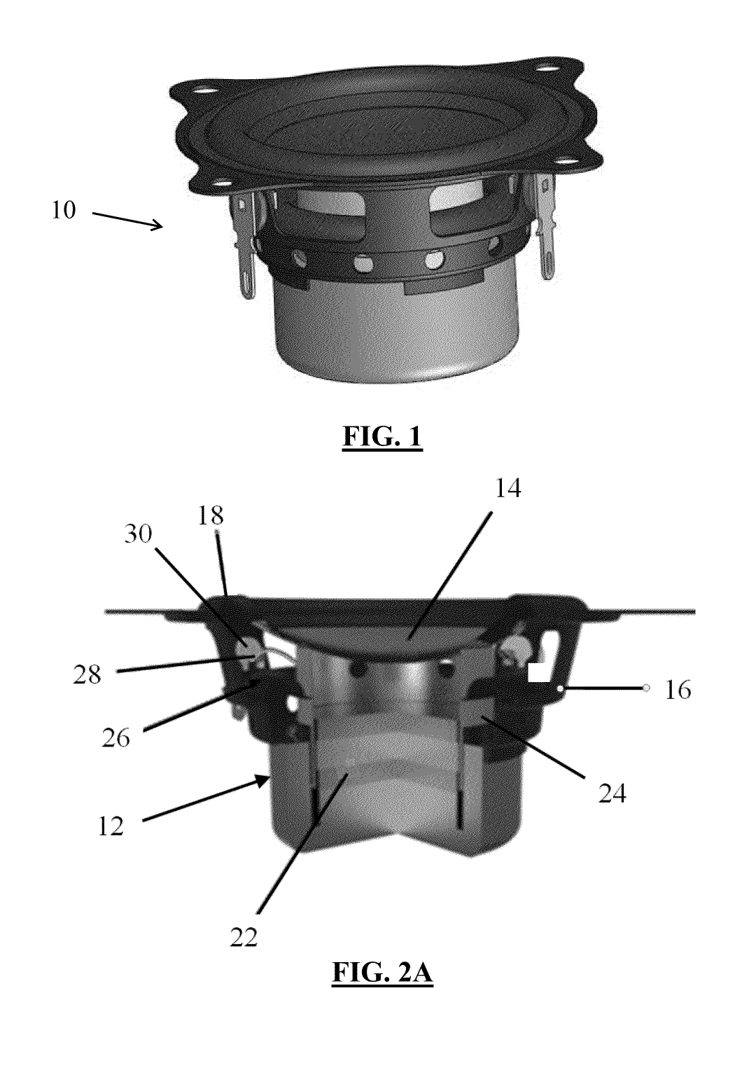

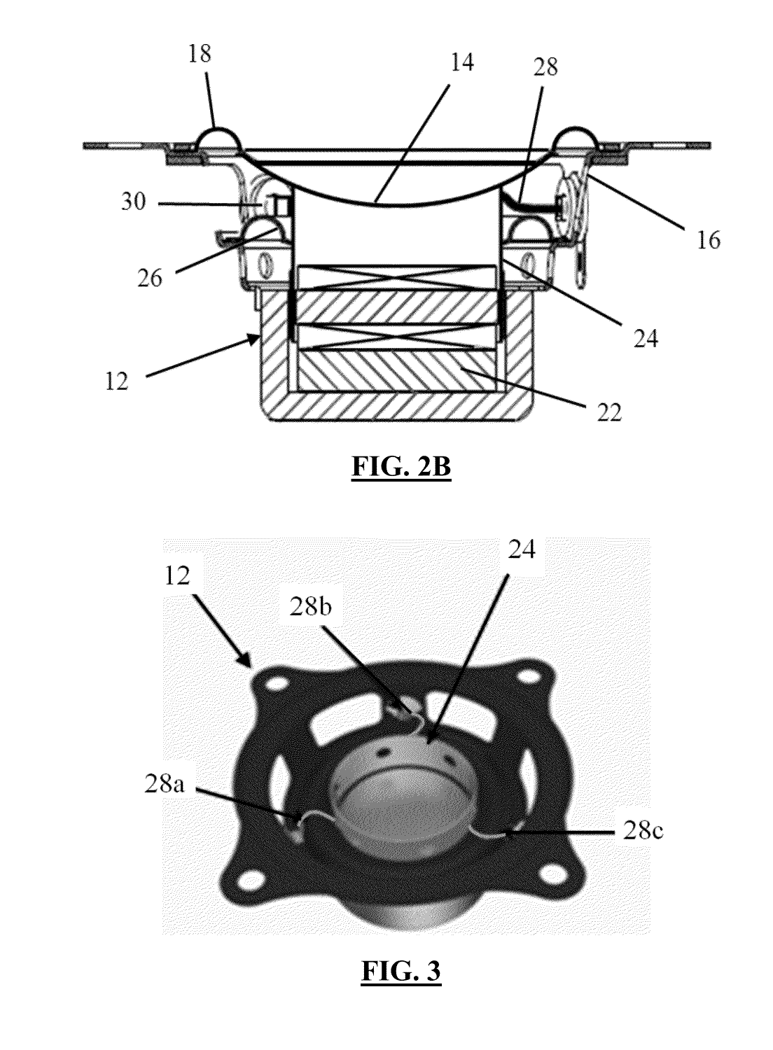

By way of example, and referring to the FIGS. 1-5, one embodiment of the present system 10 comprises a speaker with a diaphragm, frame, motor assembly, and two suspension assemblies, known as a surround and spider. These motor assembly components can be of any sort commonly known to those skilled in the art and are thus not described herein. As shown in FIGS. 1 and 2A/2B, embodiment 10 comprises a speaker 12, which itself comprises a diaphragm 14 coupled to a speaker frame 16 via a surround suspension 18. The speaker frame 16 serves as the chassis to which all components of a speaker are coupled to in some fashion. Speaker 12 further comprises a magnet assembly 22, which directs linear movement of a voice coil 24, supported by a spider 26, to which one of a plurality of wires 28 connect at one end of the wires. The other end of the wires 28 connects to anchors 30 on the frame 16. In this regard, speaker 12 is not unlike many speakers in terms of basic components, although the present invention herein is applicable to speakers having various configurations and with varied components and subassemblies.

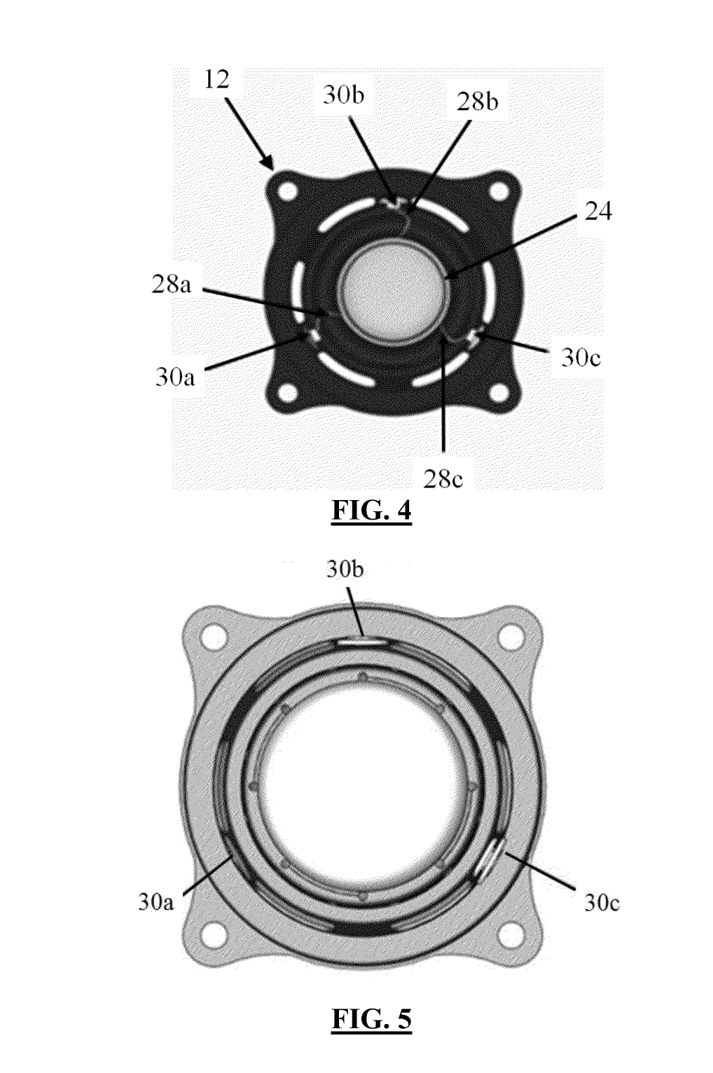

Referring to FIGS. 3 through 5, a preferred embodiment comprises three wires 28a, 28b and 28c connected to voice coil 24 at a first end of each wire, where a second end of each wire is connected to corresponding anchors 30a, 30b and 30c, respectively, on the speaker frame. In one embodiment, the multi-wire stabilization assembly comprises three wires made of a flexible conductive metal, such as tinsel wire or braided wire that provide sufficient support to reduce wobbling of the voice coil 24 while also retaining an amount of flexibility for linear excursion during operation. In a preferred arrangement, one conductive wire 28a is configured to carry a positive charge, while another wire 28c is configured to carry a negative charge. These two wires pass the alternating current electrical signal. The third wire in the embodiments of FIGS. 3 and 4 are connected to an unused terminal, such as shown in FIG. 5, where anchors 30a, 30b and 30c function as a positive terminal, a negative terminal and an unused terminal, respectively, for example.

In some embodiments, the wires 28 are coupled to the voice coil 24 with adhesive, and are secured on the other end via individual mounts 30 that are preferably an extension of the speaker frame 16. The wires 28 are preferably arranged at equal distances apart at about 120 degrees. The wires 28 between the voice coil 24 and the mounts 30 preferably are configured to maintain a minimal amount of free-play so as not to restrict the voice coil 24 and therefore the excursion of the diaphragm 14. The mounts 30 provides leverage as the wires 28 are preferably looped through them to ensure equal tension for the wires between the voice coil 24 and the mounts 30. While the wires 28 are preferably secured to mounts 30 on the frame 16, other embodiments comprise wires secured to other external structures commonly known to those skilled in the art.

Persons of ordinary skill in the art should appreciate that numerous design configurations may be possible to enjoy the functional benefits of the inventive embodiments. For example, although a preferred embodiment comprises three wires spaced radially evenly apart, it is contemplated that more than three wires may be used and, indeed, may improve stability, although there may be an expense of increased moving mass, suspension stiffness, and cost. Thus, given the wide variety of configurations and arrangements of embodiments of the present invention the scope of the invention is reflected by the breadth of the claims below rather than narrowed by the embodiments described above.

What is claimed is:

1. A speaker system comprising a voice coil and diaphragm supported within a speaker frame, the speaker system comprising a first suspension system comprising a surround securing a diaphragm to the speaker frame, a second suspension system comprising a spider connecting the voice coil to the speaker frame, and a third suspension system comprising at least three wires extending between the voice coil and the speaker frame, at least one of the wires configured to transmit a positive charge, at least another one of the wires configured to transmit a negative charge, and at least yet another one of the wires configured so as to not to carry any charge, where the three suspension systems are configured and positioned so as to permit axial movement of the voice coil to produce sound while minimizing distortion.

2. The speaker system of claim 1, where the third suspension system consists only of three wires.

3. The speaker system of claim 2, where the three wires are radially spaced at about 120 degrees apart.

4. A speaker system comprising a voice coil supported within a speaker frame, the speaker system comprising three suspension systems, a first and second suspension system secured to the voice coil and the speaker frame, wherein the first suspension system comprises at least three wires, one of which is not electrically actively.
